(19) United States
(12) Patent Application Publication
(10) Pub. No.: US 2013/0085062 A1
(43) Pub. Date: Apr. 4, 2013

(54) NOVEL FORMULATION OF HEXA-ALUMINATES FOR REFORMING FUELS

(71) Applicant: Magali S. Ferrandon, Steger, IL (US)

(72) Inventor: Magali S. Ferrandon, Steger, IL (US)

(73) Assignee: UCHICAGO ARGONNE, LLC, Chicago, IL (US)

(21) Appl. No.: 13/250,693

(22) Filed: Sep. 30, 2011

(51) Int. Cl. B01J 21/02; C01F 17/00; B01J 21/10

(52) U.S. Cl. 502/303; 502/304; 502/302; 502/306; 502/324; 502/327; 502/328; 502/341; 423/263

(57) ABSTRACT

The invention is directed to a catalyst and a method for making a reforming catalyst for the production of hydrogen from organic compounds that overcomes the problems of catalyst poisoning and deactivation by coking and high temperature sintering, yet provides excellent durability and a long working life in process use. An embodiment is the formation of a unique four-metal ion hexa-aluminate of the formula M1ₐM2_{b}M3_{c}M4_{d}Al₁₁O_{19-α}. M1 and M2 are selected from the group consisting of beryllium, magnesium, calcium, strontium, barium, lanthanum, cerium, praseodymium, neodymium, promethium, samarium, and gadolinium. M3 and M4 are selected from the group consisting of chromium, manganese, iron, cobalt, nickel, copper, molybdenum, ruthenium, rhodium, palladium, tungsten, rhenium, osmium, iridium, platinum, wherein 0.010≦a+b+c+d≦2.0. Also, 1≦α≦1. Further, M1≠M2 and M3≠M4.

### CONTRACTUAL ORIGIN OF THE INVENTION

The U.S. Government has rights in this invention pursuant to Contract No. DE-AC02-06CH11357 between the U.S. Department of Energy and the -University of Chicago representing Argonne National Laboratory.

### FIELD OF THE INVENTION

The present invention relates to hexa-aluminates. More specifically this invention relates to novel formulations of hexa-aluminates suitable for auto-thermal reforming and partial oxidation of hydrocarbon fuels.

### BACKGROUND OF THE INVENTION

The production of hydrogen for fuel cell applications from the conversion of hydrocarbon and oxygenated fuels with byproduct production of carbon monoxide and carbon dioxide takes place by a number of reaction mechanisms, including Partial oxidation (POx), steam reforming (SR) and carbon dioxide reforming in reforming reactors. Steam reforming tends to be more cost effective on a large scale. Steam reforming and carbon dioxide reforming require heat input, while POx process is exothermic and therefore self sustaining. The combination of POx and SR, auto-thermal reforming (ATR), produces hydrogen though an exothermic reaction with steam and oxygen. The byproducts of POx, SR and ATR can be uses as feedstock for Fischer-Tropsch conversion to liquid hydrocarbons. These processes are typically performed catalytically to improve process efficiencies and to favor the production of desired products.

Generally, a partial oxidation/combustion reaction first occurs as depicted in Equation 1, 2 or 3

CₓH_{y}O_{z}+(x−z/2)O₂→y/2H₂+xCO₂ (1)

CₓH_{y}O_{z}+(x/2−z/2)O₂→y/2H₂+xCO (2)

CₓH_{y}O_{z}+(x+y/4−z/2)O₂→y/2H₂O+xCO₂ (3)

and specifically, when methane is used as the feedstock:

CH₄+½O₂→CO+2H₂ (1a)

CH₄+½O₂→2H₂+CO (2a)

CH₄+2O₂→2H₂O+CO₂ (3a)

### Steam Reforming:

For steam reforming the reaction occurs as depicted in Equation 4 and 5:

CₓH_{y}O_{z}+(x−z)H₂O→(y/2+x−z)H₂+xCO (4)

CₓH_{y}O_{z}+(2x−z)H₂O→(y/2+2x−z)H₂+xCO₂ (5)

and specifically, when methane is used as the feedstock:

CH₄+H₂O→3H₂+CO (4a)

CH₄+2H₂O→4H₂+CO₂ (5a)

Carbon dioxide reforming takes place by the following reaction:

CₓH_{y}O_{z}+(2x−z)CO₂→y/2H₂+(2x−z)CO (6)

### Auto-Thermal Reforming:

For auto-thermal reforming the reaction occurs as depicted in Equation 7:

CₓH_{y}O_{z}+rH₂O+sO₂→tH₂+uCO₂+vCO (7)

The reaction in Equations 1, 2, 3 and 1a, 2a or 3a are exothermic and provides heat necessary to drive the reforming portion of any auto-thermal reformer system, the reforming portion depicted in Equation 7:

CₓH_{y}O_{z}+rH₂O+sO₂→tH₂+uCO₂+vCO (7)

The reforming reactors typically use a metal catalyst that supports both the oxidation and reforming reactions, with the oxidation zone followed by the reforming zone. The reforming zone is where oxygen concentration is extremely low. The problem with many catalysts is that they are poisoned by the presence of sulfur or other impurities in the hydrocarbon fuels being reformed. Organic sulfur compounds remaining in the feed after desulfurization are readily hydrogenated to H₂S under typical reforming conditions; thus it is sufficient to consider poisoning by H₂S, Numerous studies have revealed that the metal-sulfur bond is so strong that catalytic activity is substantially reduced; even at extremely low (ppb levels) gas-phase concentration of hydrogen sulfide [Bartholomew et al., Advances in Catalysis (1982)].

Further, many catalysts suffer from the formation of a carbonaceous layer or coking, particular at the higher temperatures, which forms a barrier on the catalyst, thereby reducing the effectiveness of the catalyst in the reaction. In extreme situations of coke formation, the catalyst may be encapsulated, thereby effectively removing the catalyst from the reaction.

The adsorption behavior of H₂S on nickel includes a dependency on the degree of coverage θₛ. Sulfur coverage, θ is defined as the ratio between the number of adsorbed sulfur atoms and the number of metallic atoms in the most superficial layer of metal. The deactivation by carbon and sulfur is more significant on large metallic clusters, and require a minimum of Ni atoms to take place [Rostrup Nielsen, Gómez, et al., 1996]. Dispersing Ni in a thermally stable structure would avoid the critical ensemble size of Ni atoms that lead to deactivation by carbon deposition of sulfur poisoning.

Further, higher temperatures tend to deactivate many metals catalysts by the reduction in the surface area available for reaction as a result of sintering or volatilization. Typical solutions to these problems have included operation with high steam: carbon ratio, operation at lower temperatures and removal of sulfur prior to introduction into the reformer. Operation of the process at high steam: carbon ratio or reducing the temperature normally reduces the reaction rate, thereby reducing the product yields and in particular the production of hydrogen. Chromium has been used in perovskites for stabilization in combustion reactions (Zwinkels et al, Catalysis Today (1999)).

In spite of the strongly deactivating effect of sulfur, the steam-reforming reaction is not completely inhibited. Reversibility of adsorbed sulfur on metal increases with increasing temperature and in the presence of steam [Köningen & Sjöström, 1998].

A need exists in the art for partial oxidation and auto-reforming catalysts that are durable at the higher temperatures which offer greater tolerance from sulfur and coke formation. The catalyst, the POx and ATR reactors should provide for long operating life at high operating temperatures while minimizing the reduction in reactivity through catalyst poisoning and coking. Hexa-aluminates are known to be promising catalysts and catalyst supports for high temperature applications due to their high stability. These materials have the general formula ABₓAl₁₂₋ₓO_{19-δ} where the A position could be an alkali, alkaline earth or a rare earth and the B position could be a metal with similar size and charge as the Al ion.

### SUMMARY OF INVENTION

An object of the invention is to provide a catalyst in auto-thermal reforming and partial oxidation applications that overcomes many of the disadvantages of the prior art catalysts.

Another object of the present invention is to provide a catalyst that suppresses/resists poisoning by sulfur-based hydrocarbon impurities. A feature of the invention is hexa-aluminate based catalyst that resists reaction with sulfur-based compounds present in the hydrocarbon. An advantage of the invention is the catalyst does not readily react with sulfur to form inactive sulfur/catalyst compounds.

Another object of the present invention is to provide a catalyst resists/inhibits the formation of carbon deposits on the surface of the catalyst. A feature of the invention is hexa-aluminate based catalyst that resists the formation of coke deposits on the exterior. An advantage of the invention is that coke deposits do not readily form on the surface of the catalyst, thereby providing a greater percentage of the catalyst surface available for reaction.

Another object of the present invention is to provide a catalyst that resists sintering of the catalyst structure. A feature of the invention is hexa-aluminate based catalyst that crystal growth does not increase significantly at higher temperature. An advantage of the invention is the catalyst maintains an open pore structure and a relatively high surface area at higher temperatures.

Briefly, the invention provides a catalyst for use in partial oxidation and auto-thermal reformer reactors, the catalyst of the formula M1ₐM2_{b}M3_{c}M4_{d}Al₁₁O_{19-α}. M1 and M2 are selected from the group consisting of beryllium, magnesium, calcium, strontium, barium, lanthanum, cerium, praseodymium, neodymium, promethium, samarium, and gadolinium. M3 and M4 are selected from the group consisting of chromium, manganese, iron, cobalt, nickel, copper, molybdenum, ruthenium, rhodium, palladium, tungsten, rhenium, osmium, iridium, platinum, wherein 0.010≦a+b+c+d≦2.0. Also, 0≦α≦1. Further, M1≠M2 and M3≠M4. In one embodiment of the invention, M1 is selected from the group consisting of magnesium, calcium, strontium and barium. In another embodiment of the invention M2 is selected from the group consisting of lanthanum, cerium, praseodymium, neodymium and promethium. In still another embodiment of the invention M3 is selected from the group consisting of chromium, cobalt and nickel. In another embodiment of the invention, M4 is selected from the group consisting of ruthenium, rhodium, rhenium and osmium. Further, in an embodiment the ratios may be such that 0.2≦a+b≦1.0 and 0.2≦c+d≦1.0. In one embodiment the formula of the catalyst is SrₐLa_{b}Cr_{c}Rh_{d}Al₁₁O₁₈, where a, b, c and d are as defined above. In one embodiment, the formula of the catalyst is Sr_{0.8}La_{0.2}Cr_{0.8}Rh_{0.2}Al₁₁O₁₈, wherein a and c are equal to zero. In one embodiment the formula CeNiAl₁₁O₁₉.

Further, the invention includes a method for forming a catalyst comprising, combine alumina nitrate (AlN₃O₉.xH₂O) a first metal nitrate, a second metal nitrate, a third metal nitrate and a forth metal nitrate, where 0≦x≦1, in an aqueous solvent to form a nitrate solution, where M1 and M2 are selected from the group consisting of beryllium, magnesium, calcium, strontium, barium, lanthanum, cerium, praseodymium, neodymium, promethium, samarium, gadolinium; M3 and M4 are selected from the group consisting of chromium, manganese, iron, cobalt, nickel, copper, molybdenum, ruthenium, rhodium, palladium, tungsten, rhenium, osmium, iridium, platinum; 0.010≦a+b+c+d≦2.0, providing a solution of ammonium carbonate at a temperature of from about 50° C. to about 80° C.); adding the nitrate solution to the ammonium carbonate solution to form a precipitate and collect the precipitate product of the formula M1ₐM2_{b}M3_{c}M4_{d}Al₁₁O_{19-α} where 0.010≦a+b+c+d≦2.0 and wherein 0≦α≦1. In an embodiment of the invention wherein the ratios of the elements is 0.2≦a+b≦1.0 and 0.2≦c+d≦1.0

In an embodiment of the invention the method of claim 10 further comprising heating the product to a temperature from about 900° C. to about 1200° C. In another embodiment of the invention, the method of claim 10 further comprising grinding the catalyst to a catalyst with a surface are greater than 20 m²/gram. The grinding step may be performed in a ballmill.

In one embodiment of the invention, the method for forming a catalyst comprising, combining alumina nitrate (AlN₃O₉.9H₂O) a strontium nitrate (Sr(NO₃)₂) a lanthanum nitrate (La(NO₃).6H₂O) a chromium nitrate (Cr(NO₃)₃.9H₂O) and a rhodium nitrate (Rh(NO₃)₃.2H₂O) in an aqueous solvent to form a nitrate solution providing a solution of ammonium carbonate at a temperature of from about 50° C. to about 80° C.; adding the nitrate solution to the ammonium carbonate solution to form a precipitate the product.

### BRIEF DESCRIPTION OF DRAWING

The invention together with the above and other objects and advantages will be best understood from the following detailed description of the preferred embodiment of the invention shown in the accompanying drawings, wherein:

FIG. 1 is a graph of products and reactants gases (mL/min) during the ATR of isobutane using Sr_{0.8}La_{0.2}r_{0.8}Rh_{0.2}Al₁₁O₁₈.

FIG. 2. O₂ consumption and H₂ formation (mL/min) during the ATR of isobutane using 2 wt % Rh supported on LaAl₁₁O₁₈ (LAO), BaAl₁₂O₁₉ (BAO) and CaAl₁₂O₁₉(CAO) calcined at 1100° C., 2 wt % Rh on Gd-Ceria (CGO20) calcined at 800° C. and Sr_{0.8}La_{0.2}Cr_{0.8}Rh_{0.2}Al₁₁O₁₈.

FIG. 3. CH₄ formation (mL/min) during the ATR of isobutane using 2 wt % Rh supported on LaAl₁₁O₁₈ (LAO), calcined at 1100° C., 2 wt % Rh on Gd-Ceria (CGO20) calcined at 800° C. and Sr_{0.8}La_{0.2}Cr_{0.8}Rh_{0.2}Al₁₁O₁₈.

FIG. 4. O₂ consumption (mL/min) during the two successive POx runs of methane using various hexa-aluminates.

FIG. 5. H₂ production (mL/min) during the second POx run of methane using various hexa-aluminates.

FIG. 6. H₂, CO, CO₂ and CH₄ yields during ATR using Sr_{0.8}La_{0.2}Cr_{0.8}Rh_{0.2}Al₁₁O₁₈.

FIG. 7. H₂, CO, CO₂ and CH₄ yields (A) and non-C₁ hydrocarbons (B) during the ATR of JP8 for Sr_{0.8}La_{0.2}Cr_{0.8}Rh_{0.2}Al₁₁O₁₈ monolith. O₂:C=0.57, H₂O:C=3.60, GHSV=14 000 h⁻¹. Furnace is at 900° C.

FIG. 8. Surface area measurements of Rh and Ni based samples after calcination with and without wet ballmilling.

FIG. 9. Equilibrium values calculated by HSC for O₂:C=0.5 molar ratio. FIGS. 10-12 show for the Rh-based hexa-aluminates calcined at 1000, 1100° C. and 1200° C. FIGS. 13 and 14 show for Ni-based hexa-aluminates calcined at 1000° C. and 1100° C.

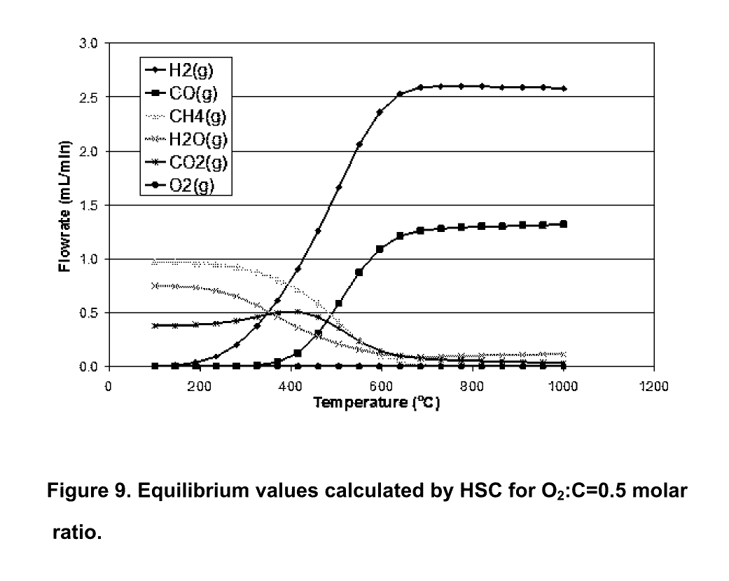

FIG. 10 shows stabilization after 5 redox cycles.

FIG. 11 does not show stabilization after 20 redox cycles.

FIG. 12 shows stabilization after 5 redox cycles.

FIG. 13 shows enhancement after 5 redox cycles for Nickel-based catalyst calcined at 1100° C.

FIG. 14 shows enhancement and stabilization after 5 redox cycles for Nickel-based catalyst calcined at 1100° C.

### DETAILED DESCRIPTION OF THE INVENTION

The foregoing summary, as well as the following detailed description of certain embodiments of the present invention, will be better understood when read in conjunction with the appended drawings.

As used herein, an element or step recited in the singular and preceded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

The invention is a catalyst and a method for making a reforming catalyst for the production of hydrogen from organic compounds that overcomes the problems of catalyst poisoning and deactivation by coking and high temperature sintering, yet provides excellent durability and a long working life in process use.

An embodiment is the formation of a unique four-metal ion hexa-aluminate of the formula M1ₐM2_{b}M3_{c}M4_{d}Al₁₁O_{19-α}. M1 and M2 are selected from the group consisting of beryllium, magnesium, calcium, strontium, barium, lanthanum, cerium, praseodymium, neodymium, promethium, samarium, and gadolinium. M3 and M4 are selected from the group consisting of chromium, manganese, iron, cobalt, nickel, copper, molybdenum, ruthenium, rhodium, palladium, tungsten, rhenium, osmium, iridium, platinum, wherein 0.010≦a+b+c+d≦2.0. Also, 1≦α≦1. Further, M1≠M2 and M3≠M4. In one embodiment of the invention, M1 is selected from the group consisting of magnesium, calcium, strontium and barium. In another embodiment of the invention M2 is selected from the group consisting of lanthanum, cerium, praseodymium, neodymium and promethium. In still another embodiment of the invention M3 is selected from the group consisting of chromium, cobalt and nickel. In another embodiment of the invention, M4 is selected from the group consisting of ruthenium, rhodium, rhenium and osmium. Further, in an embodiment the ratios may be such that 0.2≦a+b≦1.0 and 0.2≦c+d≦1.0. In one embodiment the formula of the catalyst is SrₐLa_{b}Cr_{c}Rh_{d}Al₁₁O₁₈, where a, b, c and d are as defined above. In one embodiment, the formula of the catalyst is Sr_{0.8}La_{0.2}Cr_{0.8}Rh_{0.2}Al₁₁O₁₈. In one embodiment of the invention a and c are equal to zero. In one embodiment the formula CeNiAl₁₁O₁₉

The catalyst of this invention provides the means for improved performance in partial oxidation, steam reforming and autothermal reforming of hydrocarbons to produce hydrogen. The catalyst provides improved resistance to sulfur poisoning by H₂S. Further, the catalyst resists surface area reduction at high temperatures due to sintering. This permits use of the catalyst at higher temperature, thereby minimizing deactivation by coke formation and sulfur poisoning.

### Synthesis of Hexa-Aluminates

### Sr_{0.8}La_{0.2}Cr_{0.8}Rh_{0.2}Al₁₁O₁₈

Preparation of hexa-aluminates of general formula ABₓAl₁₂₋ₓO₁₈, by carbonate route (Lietti et al. Catal. Today [2000]). Rhodium was added with the aim of it being inserted and stabilized in the hexa-aluminate structure. Nitrates of alumina (AlN₃O₉.9H₂O), strontium (Sr(NO₃)₂), lanthanum (La(NO₃).6H₂O), chromium (Cr(NO₃)₃.9H₂O) and rhodium nitrate (Rh(NO₃)₃.2H₂O, Alfa Aesar, 31.83 wt %) were dissolved in 300 mL water. Ammonium carbonated dissolved in 800 mL water in an open flask and heated up to 60° C. Nitrates were added drop wise to the solution of ammonium carbonate. Precipitation occurred immediately. PH of the solution was constant at 7-8 due to the buffer capability of the system. Precipitates obtained were centrifuged, dried overnight at 100° C. and calcined at 1100° C. for 4 hour (2° C./min). The target composition was Sr: 9.27 wt %, La: 3.65 wt %, Cr: 5.47 wt %, Rh: 2.70 wt %, and Al: 38.99 wt %. After the precipitation, the mother liquor was clear indicating that Rh nitrate (which is black) has precipitated. The final content of Rh is 3.4 wt %, which is more than we expected.

Other hexa-aluminates were prepared by the carbonate route: CaAl₁₂O₁₉, LaAl₁₁O₁₈, BaAl₁₂O₁₉, BaCrAl₁₁O₁₈, BaFeAl₁₁O₁₈, BaNiAl₁₁O₁₈, CeNiAl₁₁O₁₉, LaNiAl₁₁O₁₈, Sr_{0.8}La_{0.2}MnAl₁₁O₁₈, and Sr_{0.8}La_{0.2}Cr_{0.5}Ni_{0.5}Al₁₁O₁₉.

The method is the carbonate route, using nitrates, as described for the preparation of hexa-aluminate above. Final calcination is at 1100° C. for 4 hours (2° C./min).

For comparison, Rh was impregnated by the incipient wetness technique on hexa-aluminate supports that do not contain transition metals: Rh on CaAl₁₂O₁₉, LaAl₁₁O₁₈, and BaAl₁₂O₁₉. After impegnation and drying, the samples were calcined at 700° C. For comparison, Rh was impregnated on ceria doped with 20% gadolinia (CGO20), pre-calcined at either 600 or 800° C.

### Preparation of Monoliths

4 g of calcined powders were suspended in a slurry containing 4 g ethanol and 26 g millipore water. The slurry was ball milled overnight using dense-alumina balls. Cordierite monoliths (400 cpsi, 29 cells, 3.57 cm length, and 1.73 mL volume) were dipped in the slurry for a few minutes and air was blown through the channels to remove excess air. The monoliths were then dried for half an hour to an hour at 110° C. Several dipping were necessary for achieving ca 200 g/L washcoat loading, which corresponds to 0.34 g washcoat/monolith. Finally the monoliths were heated up to 200° C. for 1 hour to fix the washcoat.

### Characterization of the Hexa-Aluminates

X-ray diffraction (XRD) technique was used to identify the phase composition of the hexa-aluminates. In addition, N₂ gas adsorption was used based on the BET (Brunnauer-Emmet-Teller) theory, to measure the surface area of the pores.

### Phase Composition Obtained by XRD

Table 1 presents XRD analyses of some samples calcined at 1100° C. Hexa-aluminate phases were obtained for those samples, except for the BaNiAl₁₁O₁₉. It should be mentioned that for Sr_{0.8}La_{0.2}Cr_{0.8}Rh_{0.2}Al₁₁O₁₈ no Rh oxide was detected beside the LaNiAl₁₁O₁₉ phase, while it was when supported on LaAl₁₁O₁₈ for instance, indicating that Rh is probably well dispersed in the structure instead of being on the surface. Another indication was the green color of the sample (Rh oxide is brown to black). Another fact that can help us to show that Rh is stabilized in the structure is its amount, determined by ICP-AES (3.4 wt %). Volatilization of Rh would have decreased the amount, especially after a calcination temperature at 1100° C.

TABLE 1
Crystalline phase composition determined from XRD analyses

| Samples | Phase composition (XRD) |
|---|---|
| BaNiAl₁₁O₁₉ | δ-Al₂O₃, Ni_{0.34}Al₁₁O₁₆ |
| LaNiAl₁₁O₁₉ | LaNiAl₁₁O₁₉, LaAl₁₁O₁₈, LaAlO₃ |
| Sr_{0.8}La_{0.2}Cr_{0.5}Ni_{0.5}Al₁₁O₁₉ | NiAl₁₀O₁₆, LaNiAl₁₁O₁₉ |
| Sr_{0.8}La_{0.2}Cr_{0.8}Rh_{0.2}Al₁₁O₁₈ | δ-Al₂O₃, LaAl₁₁O₁₈ |

### Surface Area Measurement

Surface area of hexa-aluminates and Rh supported on CGO20, CaAl₁₂O₁₉, LaAl₁₁O₁₈, BaAl₁₂O₁₉ and LaNiAl₁₁O₁₉ are reported in Table 2. Despite the higher temperature of calcination of the hexa-aluminates support (1100° C.) compared to that of CGO20 (800° C.), the surface areas of the hexa-aluminates are larger.

TABLE 2
BET surface area (m²/g) measurements.

| | Surface |
|---|---|
| Samples | area (m²/g) |
| 2 wt % Rh/CGO20 (CGO20 calcined at 600° C.) | 36 |
| 2 wt % Rh/CGO20 (CGO20 calcined at 800° C.) | 18 |
| 2 w % Rh/LaAl₁₁O₁₈ (LaAl₁₁O₁₈ calcined at 1100° C.) | 37 |
| 2 w % Rh/LaAl₁₁O₁₈ (LaAl₁₁O₁₈ calcined at 1200° C.) | 16 |
| 2 wt % Rh/CaAl₁₂O₁₉ (CaAl₁₂O₁₉ calcined at 1100° C.) | 45 |
| 2 wt % Rh/CaAl₁₂O₁₉ (CaAl₁₂O₁₉ calcined at 1200° C.) | 11 |
| 2 wt % Rh/CaAl₁₂O₁₉ (CaAl₁₂O₁₉ calcined at 1100° C.) | 97 |
| 2 wt % Rh/CaAl₁₂O₁₉ (CaAl₁₂O₁₉ calcined at 1200° C.) | 17 |
| LaNiAl₁₁O₁₉ | 25 |

### Thermal Treatments

Thermal treatment has been performed in a similar way on different samples to be able to compare the loss of metal and surface area before and after a treatment in reducing and steamy atmosphere. Samples were subjected to a thermal treatment in a furnace at 900° C. for 24 h with a flow of 200 mL/min of 33% H₂ in He passing through a bubbler heated up at 60° C. in order to have 17% steam. BET surface area measurements and elemental analyses (using ICP-AES) were conducted on the samples freshly calcined and after having been subjected to the treatment (Table 3). BET measurements showed a strong loss of surface area of support (from 36 to 3-4 m²/g) for CGO20, while for Rh on LaAl₁₁O₁₈(1100 C), the loss of surface area is much smaller. For Sr_{0.8}La_{0.2}Cr_{0.8}Rh_{0.2}Al₁₁O₁₈, the BET surface area increased after thermal treatment and this has been checked by several reproducibility BET tests. The loss of noble metals is particularly important for the Pt-based commercial catalyst (41% loss), while for the other samples, and in particular the hexylaaluminates, the loss is negligible.

TABLE 3
BET surface area measurements (m²/g) and loss of metal
determined by elemental analyses before and after hydrothermal treatment
(900° C. 24 h, 33% H₂, 17% H₂O).

| | Surface area | Surface area | Loss of |
|---|---|---|---|
| | before treatment | after treatment | metal |
| Samples | (m²/g) | (m²/g) | (%) |
| Pt commercial catalyst | 38 | 1 | 41 |
| 4 wt % Pt/CGO20 | 36 | 4 | 8 |
| 2 wt % Rh/CGO20 | 36 | 3 | 8 |
| 2 wt % Rh/LaAl₁₁O₁₈ | 37 | 33 | <1 |
| (LaAl₁₁O₁₈ calcined at | | | |
| 1100° C.) | | | |
| Sr_{0.8}La_{0.2}Cr_{0.8}Rh_{0.2}Al₁₁O₁₈ | 45 | 52 | 0 |

### Activity Measurements

The activity of the catalysts was tested for various fuels and conditions for short and long-term periods. Short-term tests (#1 and 2) were conducted in a commercial Zeton Altamira microreactor (AMI-100) and long-term tests (#3 and 4) in home-made microreactors. Table 4 summarizes the conditions for the tests performed.

TABLE 4
Test conditions for the various auto-thermal reforming (ATR)
and partial oxidation (POx) of fuels.

| | | | Amount | | | |
|---|---|---|---|---|---|---|
| | Re- | | of | Ratio | Ratio | Flowrates |
| Test | action | Fuel | catalyst | H₂O:C | O₂:C | (mL/min) |
| #1 | ATR | Isobutane | 50 mg | 1 | 0.5 | Fuel = 0.18 |
| | | | powder | | | Water = 0.60 |
| | | | | | | Oxygen = 0.55 |
| | | | | | | Helium = bal. |
| | | | | | | Total = 50 |
| #2 | POx | Methane | 50 mg | 0 | 0.5 | Fuel = 1.5 |
| | | | powder | | | Oxygen = 0.75 |
| | | | | | | Inert = bal. |
| | | | | | | Total = 50 |
| #3 | ATR | Bench- | 1 mL | 1.6 | 0.4 | Fuel = 27 |
| | | mark | powder | | | Water = 340 |
| | | fuel^{a} | | | | Oxygen = 88 |
| | | | | | | Nitrogen = bal. |
| | | | | | | Total = 786 |
| #4 | ATR | JP8 | 1 mL | 3.60 | 0.57 | Fuel = 10 |
| | | military | monolith | | | Water = 231 |
| | | fuel | | | | Oxygen = 37 |
| | | | | | | Nitrogen = bal. |
| | | | | | | Total = 416 |

^{a}Xylene (16 vol %), isooctane (78 vol %), methylcyclohexane (5 vol %) and 1-pentene (1 vol %)

### ATR of Isobutane (Test Condition #1)

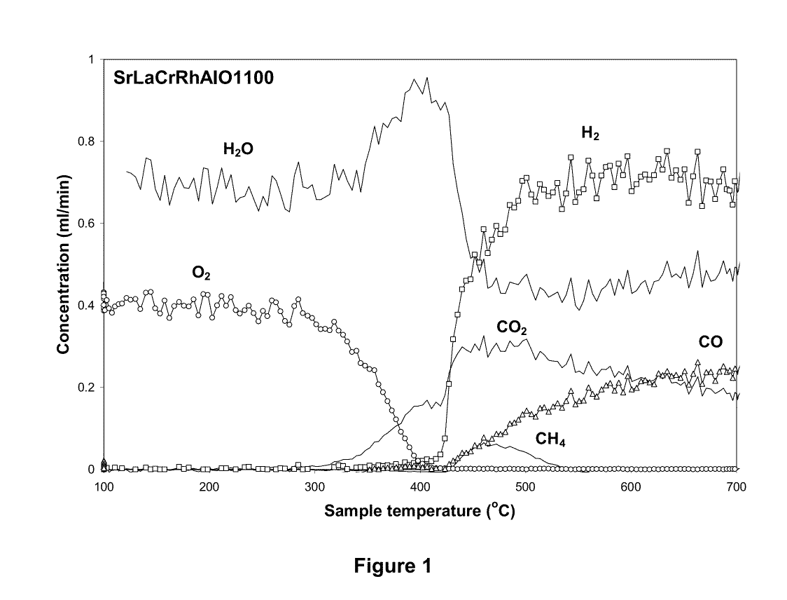

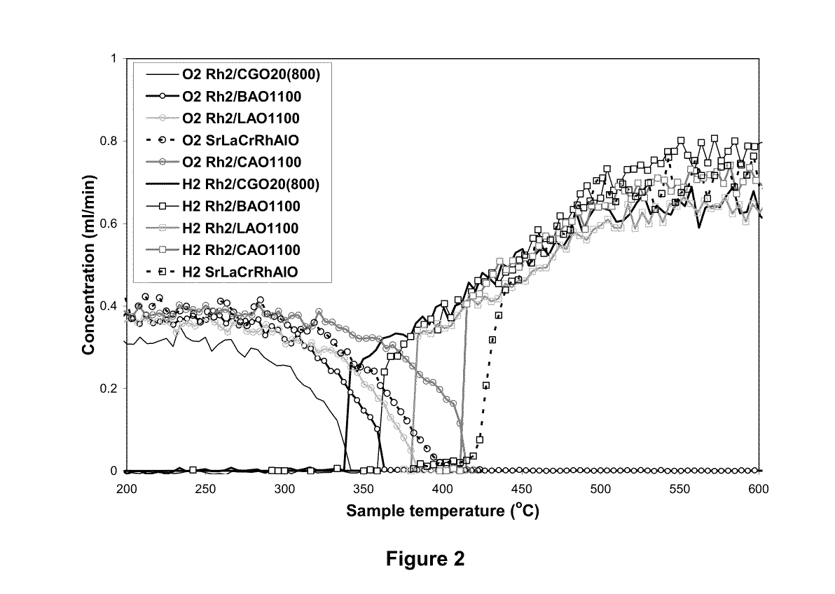

Scanning tests were performed on Sr_{0.8}La_{0.2}Cr_{0.8}Rh_{0.2}Al₁₁O₁₈ (FIG. 1), and comparison with Rh supported on Gd-doped Ceria (CGO20), LaAl₁₁O₁₈, CaAl₁₂O₁₉ and BaAl₁₂O₁₉ pre-calcined at 1100° C. or 1200° C. prior to impregnation of Rh are shown in FIGS. 1 and 2.

Contrarily to all the samples with Rh deposited onto the support, for Sr_{0.8}La_{0.2}Cr_{0.8}Rh_{0.2}Al₁₁O₁₈ the reforming reaction does not proceed right after the isobutane is fully converted (FIG. 2). Probably the encapsulation of Rh into the hexa-aluminate structure makes the diffusion of the reactant more difficult, and therefore slow down the reforming light-off.

Some of the hexa-aluminates show some activity for oxidation, particularly those 2 containing altogether Sr and La, i.e, Sr_{0.8}La_{0.2}MnAl₁₁O₁₉ and Sr_{0.8}La_{0.2}Cr_{0.8}Rh_{0.2}Al₁₁O₁₈ (Table 5). Their activities for oxidation are comparable to those of Rh samples. Most of the hexa-aluminates do not show any good activity for steam reforming of isobutane except the Sr_{0.8}La_{0.2}Cr_{0.8}Rh_{0.2}Al₁₁O₁₈. One hexa-aluminate, LaNiAl₁₁O₁₉, has been tested to higher temperature, and it started to show some activity for reforming (0.2 mL H₂/min) at 900° C. We can expect activities for these hexa-aluminates (without any Rh) at high temperatures, as reported for BaNiAl₁₁O₁₈ [Chu et al., 2002].

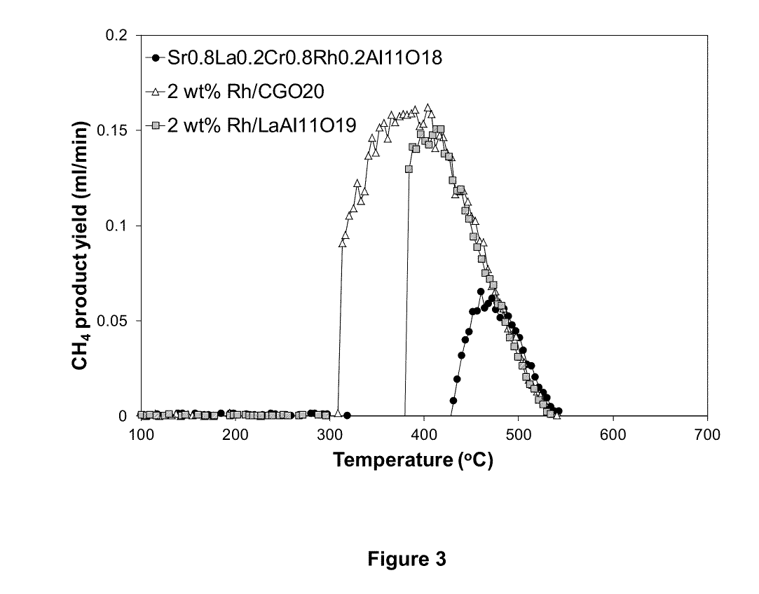

According to the results, all Rh samples produces methane between ca 330° C. and 580° C. (Table 5), while no formation of methane has been observed for Pt during the course of the ATR experiments. Rh is indeed known to be a methanation catalyst. Interestingly, Rh/BaAl₁₂O₁₉(1100) and Rh/CGO20(600) produce the highest content of methane compared to the other Rh samples, i.e. a maximum of ca 0.20 mol at ca 400° C. For the samples of which the support has been calcined at 1200° C., the production of CH₄ decreases, especially for Rh/CaAl₁₂O₁₉ and Rh/BaAl₁₂O₁₉. Sr_{0.8}La_{0.2}Cr_{0.8}Rh_{0.2}Al₁₁O₁₈ produces the least amount of CH₄ (0.05 mL/min). However, above 600° C. there is no production of methane for all samples (FIG. 3).

TABLE 5
Results from the ATR of isobutane

| | Temp. | Temp. | Temp. | Temp. | CH₄ |
|---|---|---|---|---|---|
| | (° C.) at | (° C.) at | (° C.) at | (° C.) of | max. |
| | 0.20 mL | 0.20 mL | 0.50 mL | methane | flowrate |
| | O₂/min | H₂/min | H₂/min | production | (mL/min) |
| 2 wt % Rh/LaAl₁₁O₁₈ | 354 | 384 | 460 | 380-535 | 0.15 |
| (LaAl₁₁O₁₈ calcined at | | | | | |
| 1100° C.) | | | | | |
| 2 wt % Rh/LaAl₁₁O₁₈ | 401 | 420 | 460 | 422-535 | 0.14 |
| (LaAl₁₁O₁₈ calcined at | | | | | |
| 1200° C.) | | | | | |
| 2 wt % Rh/CaAl₁₂O₁₉ | 398 | 412 | 450 | 415-535 | 0.15 |
| (CaAl₁₂O₁₉ calcined at | | | | | |
| 1100° C.) | | | | | |
| 2 wt % Rh/CaAl₁₂O₁₉ | 451 | 485 | 485 | 485-535 | 0.05 |
| (CaAl₁₂O₁₉ calcined at | | | | | |
| 1200° C.) | | | | | |
| 2 wt % Rh/BaAl₁₂O₁₉ | 340 | 362 | 446 | 356-542 | 0.20 |
| (BaAl₁₂O₁₉ calcined at | | | | | |
| 1100° C.) | | | | | |
| 2 wt % Rh/BaAl₁₂O₁₉ | 411 | 426 | 455 | 429-538 | 0.12 |
| (BaAl₁₂O₁₉ calcined at | | | | | |
| 1200° C.) | | | | | |
| BaCrAl₁₁O₁₉ | 460 | — | — | — | — |
| BaFeAl₁₁O₁₉ | 471 | — | — | — | — |
| BaNiAl₁₁O₁₉ | 586 | — | — | — | — |
| LaNiAl₁₁O₁₉ | 488 | — | — | — | — |
| Sr_{0.8}La_{0.2}MnAl₁₁O₁₉ | 430 | — | — | — | — |
| Sr_{0.8}La_{0.2}Cr_{0.5}Ni_{0.5}Al₁₁O₁₉ | 383 | — | — | — | — |
| Sr_{0.8}La_{0.2}Cr_{0.8}Rh_{0.2}Al₁₁O₁₈ | 360 | 427 | 450 | 431-547 | 0.05 |
| 2 wt % Rh/CGO20 | 268 | 302 | 446 | 285-527 | 0.20 |
| (CGO20 calcined at | | | | | |
| 600° C.) | | | | | |
| 2 wt % Rh/CGO20 | 316 | 340 | 445 | 337-527 | 0.09 |
| (CGO20 calcined at | | | | | |
| 800° C.) | | | | | |
| 4 wt % Pt/CGO20 (CGO20 | 157 | 474 | 573 | — | — |
| calcined at 800° C.) | | | | | |
| Pt commercial catalyst | 242 | 455 | 547 | — | — |

### POx of Methane (Test Condition #2)

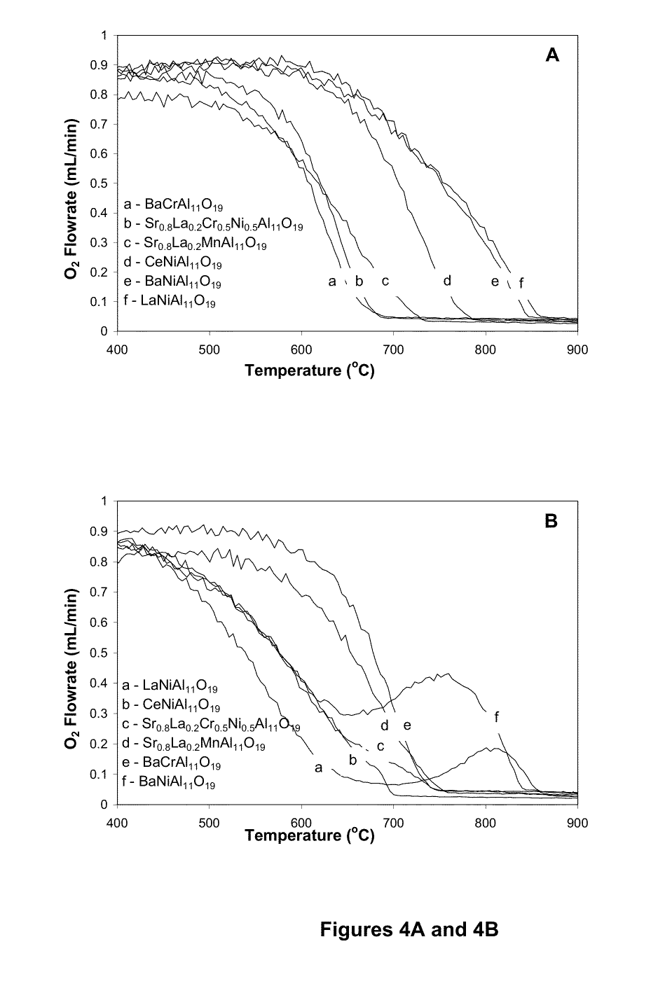

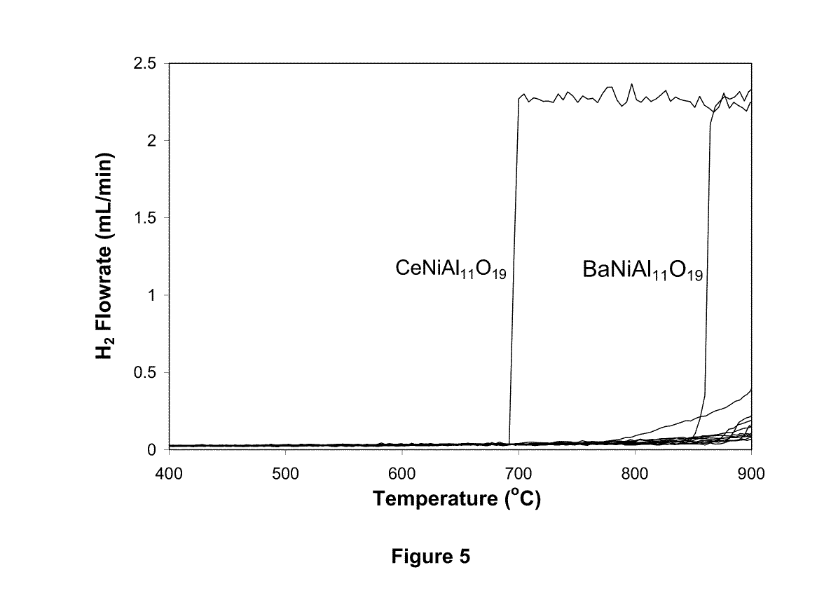

FIGS. 4 and 5 show the O₂ consumption and H₂ formation for various hexa-aluminates (calcined at 1100° C.) during the two successive POx of methane (test condition #2) up to 900° C. each at O₂:C=0.5. Among all the formulations BaNiAl₁₁O₁₉ and CeNiAl₁₁O₁₉ after the first POx run show promising H₂ production.

### ATR of Benchmark Fuel (Test Condition #3)

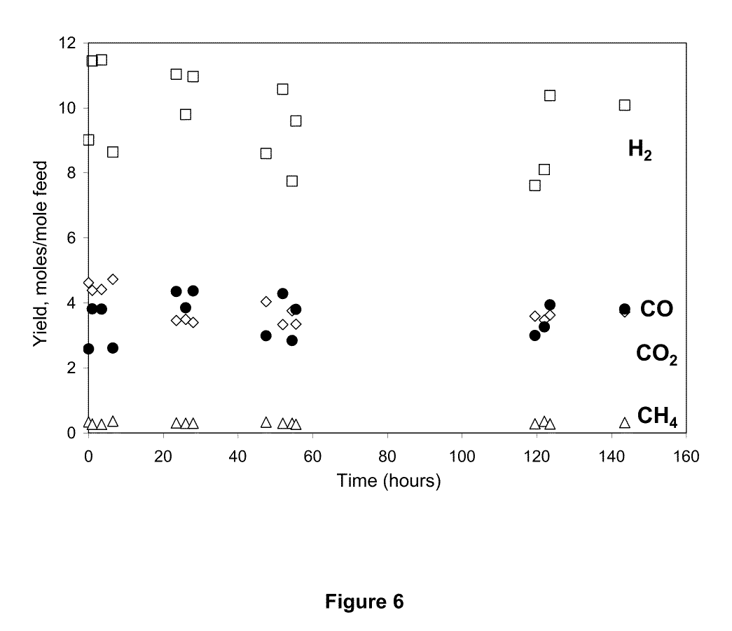

The Sr_{0.8}La_{0.2}Cr_{0.8}Rh_{0.2}Al₁₁O₁₈ was tested for a longer period of time (144 hours) for the ATR of benchmark fuel, whis is a surrogate for sulfur-free gasoline (composition is indicated in Table 4). Furnace temperature was set at ca 600° C. Results for yields of H₂, CO, CO₂ and CH₄ (moles/mole feed) are presented in the FIG. 6. The catalyst activity is relatively stable over the course of the experiment.

### ATR of JP8 Military Jet Fuel (Test Condition #4)

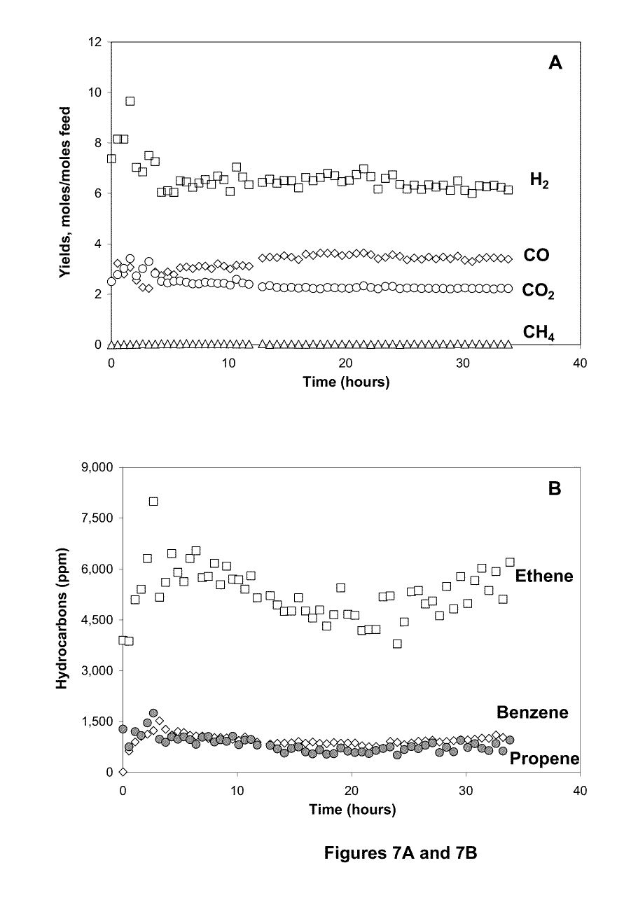

Sr_{0.8}La_{0.2}Cr_{0.8}Rh_{0.2}Al₁₁O₁₈ monolith (400 cpsi) showed stable H₂ and hydrocarbons production over the period tested, i.e., ca 30-40 hours. The H₂ production was 6 moles/mole fuel (FIG. 7A) and the amount of ethene was ca 6,000 ppm (FIG. 7B).

### Synthesis of Hexa-Aluminates—Effect of Ballmilling

A rhodium-based hexyluminate catalyst and a nickel-based hexyluminate (CeNiAl₁₁O₁₉) catalyst were prepared. The catalyst powders were synthesized per Lietti et al., then ballmilled with yttria-stabilized zirconia (YSZ) balls in water for 2 days. One sample was ballmilled for a longer period of time (1 week). XRD confirmed the presence of LaAl₁₁O₁₈ in Sr_{0.8}La_{0.2}Cr_{0.8}Rh_{0.2}Al₁₁O₁₈ calcined at 1100′C.

### Redox Cycles

The catalysts were cycled through a protocol to simulate start-up (oxidizing conditions with air, steam) and steady-state (reducing conditions with hydrogen) operations for up to 20 cycles from room temperature to 900° C. in the micro reactor, Zeton Altamira. For oxidizing conditions, a 5% O₂/He flowrate of 50 mL/min were used which pass through a water bubbler set at 80° C. For the reducing conditions, a 3% H₂/Ar flowrate of 50 mL/min were used. The system was purged at 900° C. for 1 hour with Ar between the oxidizing and reducing treatments.

### Characterization

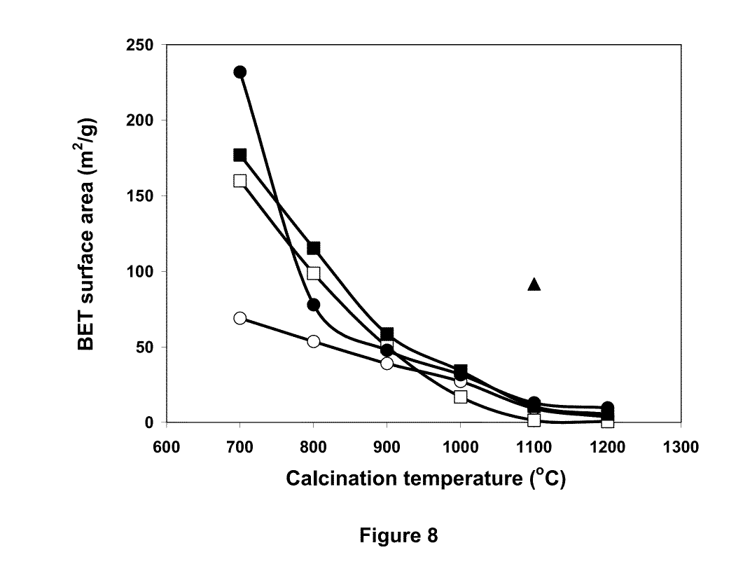

BET surface area measurements were performed on samples calcined between 700 and 1200° C. BET surface areas of the powders before and after ballmilling are shown in FIG. 8. Wet ballmilling increases the surface area, especially for the Rh-based hexaaluminate at low calcination temperature. One sample was ballmilled for one week and the surface area was increased from 9 m²/g to 13 m²/g after ballmilling for 24 hours and to 92 m²/g after ballmilling for one week.

After the 20 redox cycles in the Altamira, the BET surface areas were measured, as seen in Table 6. The presence of quartz wool in the sample taken from the Altamira reactor leads to a lower reliability of the BET results.

A wet ballmilling step is necessary to increase the initial surface area of the hexa-aluminate.

TABLE 6
BET surface area after 20 redox cycles and 4 POx
of methane before, after 5, 10 and 20 cycles.

| Calcination | | |
|---|---|---|
| temperature (° C.) | CeNiAl₁₁O₁₉ | Sr_{0.8}La_{0.2}Cr_{0.8}Rh_{0.2}Al₁₁O₁₈ |
| 1000 | 26.4 | 23.8 |
| 1100 | 10.9 | 71.2* |
| 1200 | Not determined | 2.7 |

*For this sample, the initial sample was the one ballmilled for a week and therefore had an initial surface area of 92 m²/g

### Activity Measurements

### POx of Methane (Test Condition #2)

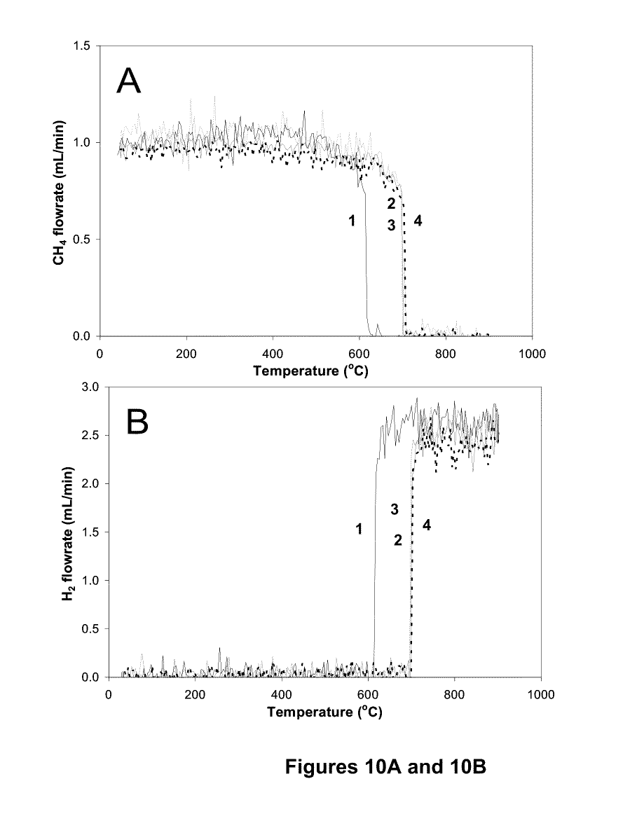

Samples of the hexyluminate catalysts, Rh- and Ni-based, were calcined at temperatures of 1000, 1100, and 1200° C. and then experiments were conducted to study their durability after repeated redox cycles in a commercial Zeton Altamira microreactor (AMI-100), which was loaded with ˜50 mg of the sample catalyst. After a set number of redox cycles (5, 10, and 20), the catalyst performance was evaluated by passing a stream of methane, oxygen, and helium through the catalyst bed while heating the bed from room temperature to 900° C., and recording the product yields using a mass spectrometer. FIG. 10 shows the equilibrium values for the partial oxidation of methane at an O₂:C=0.5 molar ratio. The full conversion of CH₄ and the maximum H₂ yield is obtained at around 685° C.

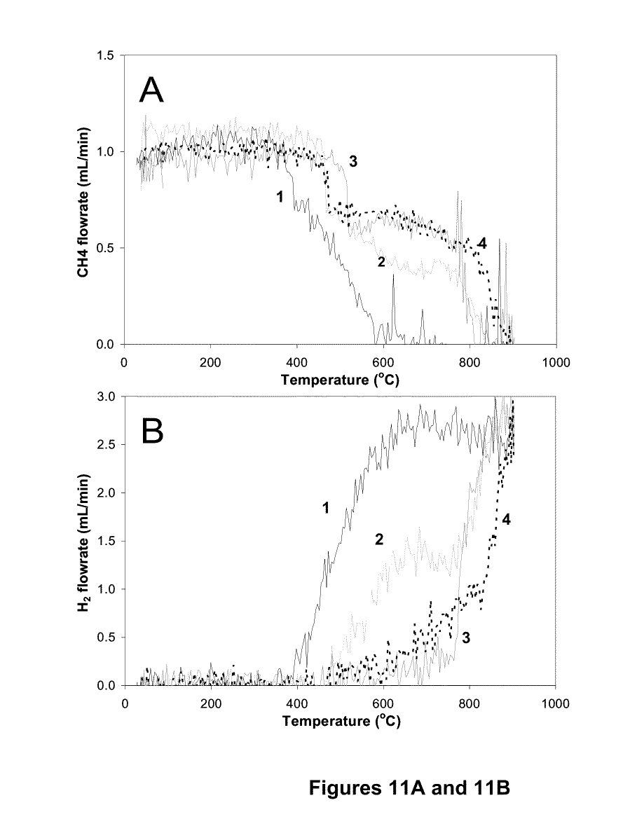

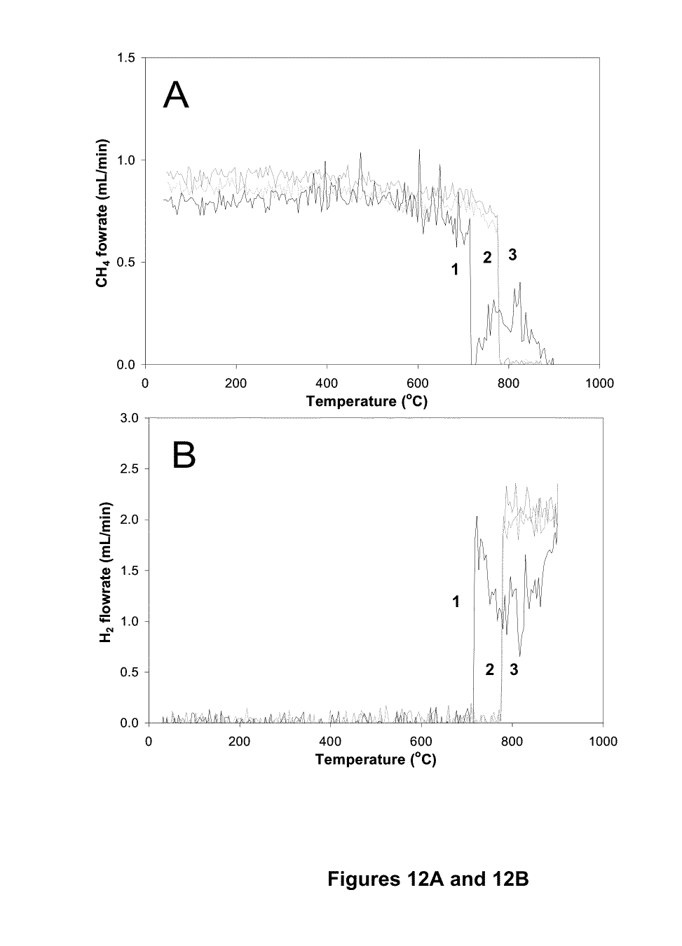

The following FIGS. 10-14 show the H₂ and CH₄ produced from the partial oxidation of methane. The curves represent the test before any redox cycle (#1), after 5 redox cycles (#2), after 10 redox cycles (#3), and after 20 redox cycles (#4).

For Sr_{0.8}La_{0.2}Cr_{0.8}Rh_{0.2}Al₁₁O₁₈ hexa-aluminates, the H₂ flowrate decreased after the first set of redox cycles, indicating deactivation (FIGS. 10-12). However, the activity seems to be stabilised then after 5, except for the samples calcined at 1100° C. whose activity continues to decline. The activity of Sr_{0.8}La_{0.2}Cr_{0.8}Rh_{0.2}Al₁₁O₁₈ decreases in that order of calcination temperature: 1000° C.>1200° C.>1100° C.

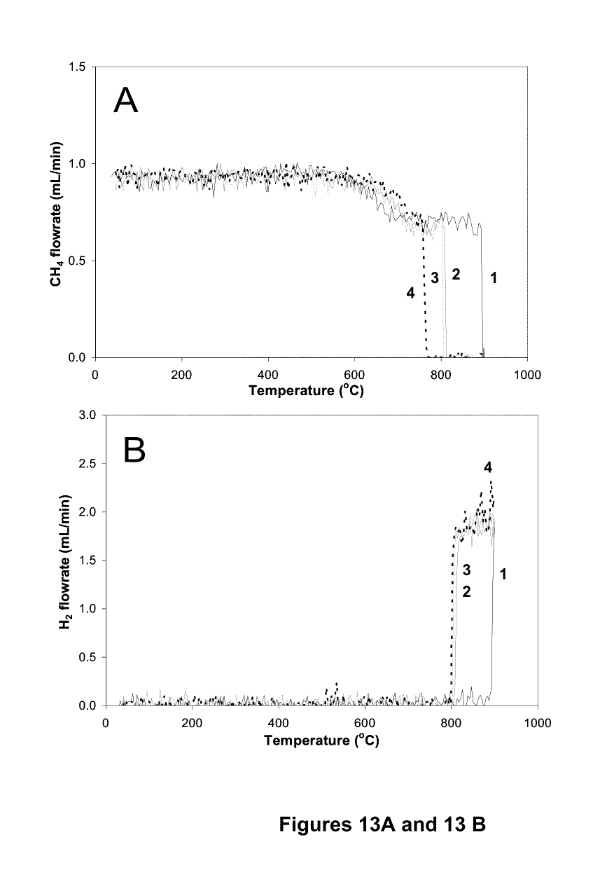

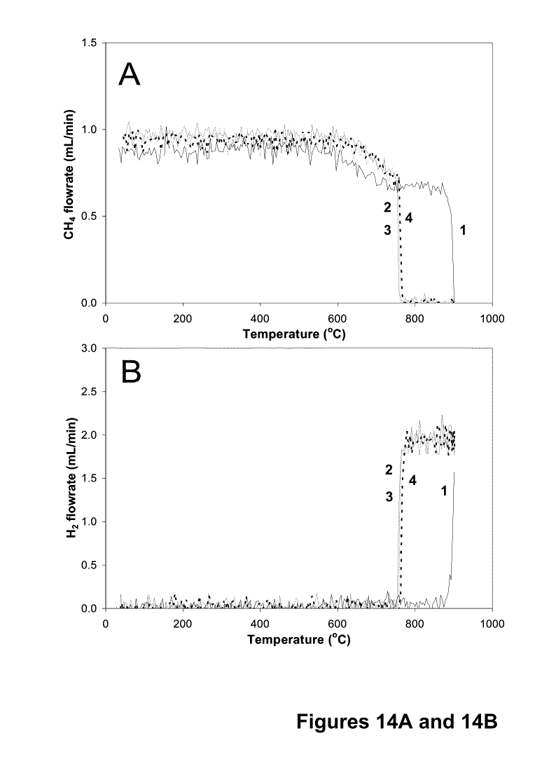

For CeNiAl₁₁O₁₉ hexa-aluminates, the H₂ yield increases after 5 redox cycles indicating an in-situ activation, and then the activity stabilizes (FIGS. 13 and 14). The CeNiAl₁₁O₁₉ hexa-aluminates (100° C. and 1100° C.) show a low temperature (810° C. and 773° C., respectively) for reaching maximum H₂ yield. The activity for CeNiAl₁₁O₁₉ decreases in that order of calcination temperature: 1100° C.>1000° C.

Among all the hexa-aluminates studied here, the Sr_{0.8}La_{0.2}Cr_{0.8}Rh_{0.2}Al₁₁O₁₈ hexa-aluminate calcined at 1000′C performs the best with a maximum H₂ yield at 725′C after 20 redox cycles. All Sr_{0.8}La_{0.2}Cr_{0.8}Rh_{0.2}Al₁₁O₁₈ hexa-aluminates show stabilisation for the partial oxidation of methane after a couple of redox cycles except for Rh hexa-aluminate calcined at 1100° C.

Both Rh and Ni-based hexa-aluminates are suitable candidates for reforming natural gas while being subjected to start-up and shutdown in oxidizing, humid or reducing environment.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

While the invention has been particularly shown and described with reference to a preferred embodiment hereof, it will be understood by those skilled in the art that several changes in form and detail may be made without departing from the spirit and scope of the invention.

The embodiment of the invention in which an exclusive property or privilege is claimed is defined as follows:

1. A catalyst comprising formula M1ₐM2_{b}M3_{c}M4_{d}Al₁₁O_{19-α}, where M1 and M2 are selected from the group consisting of beryllium, magnesium, calcium, strontium, barium, lanthanum, cerium, praseodymium, neodymium, promethium, samarium, gadolinium; M3 and M4 are selected from the group consisting of chromium, manganese, iron, cobalt, nickel, copper, molybdenum, ruthenium, rhodium, palladium, tungsten, rhenium, osmium, iridium, platinum; 0.010≦a+b+c+d≦2.0; and wherein 0≦α≦1.

2. The catalyst of claim 1, wherein M1 is selected from the group consisting of magnesium, calcium, strontium and barium.

3. The catalyst of claim 2, wherein M2 is selected from the group consisting of lanthanum, cerium, praseodymium, neodymium and promethium.

4. The catalyst of claim 3 wherein M3 is selected from the group consisting of chromium, cobalt and nickel.

5. The catalyst of claim 4 wherein M4 is selected from the group consisting of ruthenium, rhodium, rhenium, palladium, and osmium.

6. The catalyst of claim 5 comprising formula SrₐLa_{b}Cr_{c}Rh_{d}Al₁₁O₁₈.

7. The catalyst of claim 5 comprising formula Sr_{0.8}La_{0.2}Cr_{0.8}Rh_{0.2}Al₁₁O₁₈.

8. The catalyst of claim 1 wherein a and c are equal to zero.

9. The catalyst of claim 8 comprising formula CeNiAl₁₁O₁₉.

10. A method for forming a catalyst comprising,
combining alumina nitrate (AlN₃O₉.xH₂O) a first metal nitrate a second metal nitrate, a third metal nitrate and a forth metal nitrate, where 0≦x≦1, in an aqueous solvent to form a nitrate solution, where M1 and M2 are selected from the group consisting of beryllium, magnesium, calcium, strontium, barium, lanthanum, cerium, praseodymium, neodymium, promethium, samarium, gadolinium; M3 and M4 are selected from the group consisting of chromium, manganese, iron, cobalt, nickel, copper, molybdenum, ruthenium, rhodium, palladium, tungsten, rhenium, osmium, iridium, platinum; 0.010≦a+b+c+d≦2.0;
providing a solution of ammonium carbonate at a temperature of from about 50° C. to about 80° C.);
adding the nitrate solution to the ammonium carbonate solution to form a precipitate and collect the precipitate product of the formula M1ₐM2_{b}M3_{c}M4_{d}Al₁₁O_{19-α}, 0.010≧a+b+c+d≧2.0 and wherein 0≦α≦1.

11. The method of claim 10 further comprising heating the product to a temperature from about 900° C. to about 1200° C.

12. The method of claim 10 further comprises grinding the catalyst to a catalyst with a surface area greater than 20 m²/gram.

13. The method of claim 12 wherein the grinding step is performed in a ball mill.

14. The method of claim 10 wherein M1 is selected from the group consisting of magnesium, calcium, strontium and barium.

15. The method of claim 14 wherein M2 is selected from the group consisting of lanthanum, cerium, praseodymium, neodymium and promethium.

16. The method of claim 15 wherein M3 is selected from the group consisting of chromium, cobalt and nickel.

17. The method of claim 16 wherein M4 M4 is selected from the group consisting of ruthenium, rhodium, rhenium and osmium.

18. A method for forming a catalyst comprising,
combining alumina nitrate (AlN₃O₉.9H₂O) a strontium nitrate (Sr(NO₃)₂) a lanthanide nitrate (La(NO₃).6H₂O) a chromium nitrate (Cr(NO₃)₃.9H₂O) and a rhodium nitrate (Rh(NO₃)₃.2H₂O) in an aqueous solvent to form a nitrate solution;
providing a solution of ammonium carbonate at a temperature of from about 50° C. to about 80° C.);
adding the nitrate solution to the ammonium carbonate solution to form a precipitate the product of Sr_{0.8}La_{0.2}Cr_{0.8}Rh_{0.2}Al₁₁O₁₈.

19. A method for forming a catalyst comprising,
combining alumina nitrate (AlN₃O₉.9H₂O) an cerium nitrate (Ce(NO₃)₂.6H₂O) and a nickel nitrate (Ni(NO₃)₂.6H₂O) in an aqueous solvent to form a nitrate solution;
providing a solution of ammonium carbonate at a temperature of from about 50° C. to about 80° C.);
adding the nitrate solution to the ammonium carbonate solution to form a precipitate the product of CeNiAl₁₁O₁₉.
